(19) United States
(12) Patent Application Publication
(10) Pub. No.: US 2026/0249414 A1
(43) Pub. Date: Aug. 27, 2026

(54) FLEXIBLE FINISHING STATION FOR BRAKE PADS AND METHOD THEREOF

(71) Applicant: ITT Italia S.R.L., Lainate (IT)

(72) Inventor: Mauro SORBARA, Barge (IT)

(73) Assignee: ITT Italia S.R.L., Lainate (IT)

(21) Appl. No.: 18/872,547

(22) PCT Filed: Jun. 13, 2023
(86) PCT No.: PCT/IB2023/056085

§ 371 Date: Dec. 6, 2024

(30) Foreign Application Priority Data
Jun. 13, 2022 (IT) 102022000012506

(51) Int. Cl. B24B 19/28; B24B 9/06; B24B 27/00; B24B 41/06; B24B 51/00

(52) U.S. Cl. CPC B24B 19/28; B24B 9/06; B24B 27/0076; B24B 41/06; B24B 51/00

(57) ABSTRACT

A finishing station (1) configured for carrying out chamfers and/or slots on a block (5) of friction material of a brake pad (2) including a robotized articulated arm (8) provided with a head (11) rotating around a first axis (A) and carrying a tool (19) including a rigid plate (20) perpendicular to the first axis (A) and carrying a first and a second motorized holding devices (24,25), each configured to hold one brake pad (2) and rotatable in independent manner around second axes (B) parallel to the first axis (A) and arranged side by side with a first interaxis (I1); wherein a first and second grinding module (9,37) are arranged in front of the robotized articulated arm (8), each including a pair of grinding wheels (31,32; 41,42) arranged at respective interaxes identical to the first interaxis (i1).

### CROSS-REFERENCE TO RELATED APPLICATIONS

This Patent Application claims priority from Italian 5-Patent Application No. 102022000012506 filed on Jun. 13, 2022, the entire disclosure of which is incorporated herein by reference.

### Technical Field

The present invention relates to an automated grinding station for finishing brake pads, which is flexible in operation.

Here and below “flexible” means “having a ready capability to adapt to new, different, or changing requirements”.

In other words, the invention relates to a finishing grinding station able to carry out, simultaneously or in sequence, with no or minimum reconfiguration, a plurality of different machining for removing/ablating friction material from a friction material block of a brake pad in order to provide the friction material block with chamfers and/or slots of different shapes.

### Prior Art

The braking elements for vehicles generally comprise a friction material block and a support therefor, to which the friction material block is bonded, e.g. by gluing or other methods. The support usually consists of a metallic plate, also known as “backplate”.

The friction material block is hot molded under pressure, e.g. co-molded onto the support, starting from an appropriate mix of raw material components including a binder, generally organic like a thermosetting resin, fibers, abrasives, inorganic fillers, lubricants, etc.

In order to avoid generation of noises when the brake pad is in operation on a vehicle, e.g. during braking of the vehicle, the so obtained brake pad is to be subjected to a finishing operation in which at least some of the edges of the friction material block may be provided with chamfers and/or a flat face of the friction material block, opposite the support, may be provided with slots subdividing it in sections.

Finishing stations based on operating machines capable of performing a preset number of preset chamfers or slots on a friction material block of a brake pad are known and include two rails along which with two parallel chains drags the brake pads in a double line to interact with rotating grinding wheels which are arranged in stationary positions to perform chamfers on an axis that provide the angle of the chamfer by interpolation. This kind of finishing stations are capable of high production rates, up to 2100 pieces/h but are very rigid: firstly, they are specialized to carry out a single type of chamfers (or slots) always in the same position, since the flat chamfer angle is defined by the grinding wheel used with no adjustment.

Secondly, due to their structure, the operating machines are not able to perform chamfers or slots with an angle larger than 35°.

To meet flexibility requirement it has been developed a finishing station based on a robotized manipulator serving two rotating grinding wheel: the first one fixed, the second moving along an axis to reach the required position of the chamfers or slots and able to perform any type of chamfers, but the production rate is relatively low, since reaches at top speed a productivity of 600 piece per hour.

### SUMMARY OF THE INVENTION

It is an object of the present invention to provide an enhanced automated finishing station for brake pads free from the drawbacks of the prior art and in particular which is reliable, easy to be implemented and able to carry out, simultaneously or in sequence, with no or minimum reconfiguration, a plurality of chamfers and/or slots of any different shapes on a friction material block of a brake.

According to the present invention an enhanced automated finishing station for brake pads is therefore provided as defined in the appended claims.

In particular, the finishing station according to the present invention is capable of performing different types of chamfers and slots on the same brake pad, working simultaneously two pads at a time, producing chambers and slots of any inclination and any usual shape on brake pads at a rate up to 2,100 pad/hour and also any combination of slots.

A numerically controlled manipulator constituted by a robotized articulated arm (or, in the following, simply “robot”) having at least six numerically controlled axes comprises a head rotating around a first axis and provided with a tool comprising a rigid plate attached integral to the head and arranged substantially perpendicular to the first axis, and a first and a second motorized holding devices carried by the rigid plate arranged side by side. Such motorized holding devices constitute as it will be seen a seventh and eight numerical axis of the robot according to the invention.

Each first and second motorized holding device comprises a motor carried integral by the rigid plate and a clamping assembly configured to hold one vehicle brake element, so that the tool is configured to carry on simultaneously two vehicle braking elements.

The clamping assembly of each first and second holding device is configured to be rotated by the corresponding motor around a respective second axis, the second axes of the first and of the second holding device being parallel to each other and to the first axis and being arranged side by side, spaced apart with a first interaxis consisting in the distance there between, the second axes being arranged eccentrically to the first axis.

The first and second holding device are operable independently of each other by the motors.

Moreover, the clamping assembly of each first and second. holding device is configured to hold one vehicle brake element at a time by a support thereof carrying a block of friction material and arranged on the side opposite to a first face of the friction material block which is to be provided with chamfers and/or slots.

The clamping assembly of each first and second holding device is configured to keep the first face of the friction material block parallel to the rigid plate of the tool and facing a first grinding module which is part of the automated finishing station of the invention.

The first grinding module comprises a first and a second motorized head carried by a first stationary base arranged in proximity to the robotized articulated arm, the first motorized head supporting one respective first grinding wheel rotating around a third axis which is its own axis of symmetry, and the second motorized head supporting one respective second grinding wheel rotating around a fourth axis which is its own axis of symmetry;

The first and second motorized heads are rotatable around respective fifth axes arranged side by side and parallel to each other and perpendicular to the third and fourth axis of rotation of the respective first and second grinding wheel.

The fifth axes are spaced apart with a second interaxis, namely the distance from each other, identical to the first interaxis.

Furthermore, the automated finishing station of the invention also comprises: a second grinding module arranged side by side the first grinding module and in front of the robotized articulated arm; and at least one conveyor arranged between the robotized articulated arm and the first and second grinding modules.

The conveyor is configured to transport a plurality of vehicle braking elements in a row along an empty space delimited between the robotized articulated arm and the first and second grinding modules

### BRIEF DESCRIPTION OF DRAWINGS

Preferred but not limiting embodiments of the invention will be now described in more detail with reference to a number of practical working examples of implementation thereof which are solely intended to disclose in a non-exhaustive and not limiting manner the feature which are part of the content of the present disclosure, and with reference to the figures of the attached drawings, in which:

FIG. 1 shows in a schematic way a three-quarter axonometric view from above of an automated finishing station for brake elements, e.g. brake pads, realized according to the present invention;

FIG. 2 shows schematically in an enlarged scale, a three-quarter axonometric view from above of essential elements of the automated finishing station of FIG. 1, with parts removed for sake of simplicity;

FIG. 3 show schematically in elevation and in a further enlarged scale a longitudinal side view, sectioned in a radial plane, of a grinding module pertaining to the automated finishing station of FIGS. 1 and 2;

FIG. 4 shows schematically in elevation a front view of a detail of a robotized articulated arm which pertains to the automated finishing station of FIGS. 1 and 2;

FIGS. 5 and 6 show schematically in a reduced scale, a same three-quarter axonometric view from above of the grinding module of FIG. 3 in two different configuration of use;

FIG. 7 shows schematically in an enlarged scale, a three-quarter axonometric view from above of a further grinding module of the automated finishing station of FIGS. 1 and 2;

FIG. 8 shows schematically and in an enlarged scale, a three-quarter axonometric view from below of a detail of a tool carried by the robotized articulated arm of the automated finishing station of FIGS. 1 and 2 and carrying two braking elements to be finished/worked;

FIG. 9 shows schematically, and in an enlarged scale in comparison with FIG. 1, a three-quarter axonometric view from above of a robotized articulated arm which is one of the main components of the automated finishing station of FIGS. 1 and 2 and which carries the tool of FIG. 8;

FIG. 10 shows schematically, and in an enlarged scale in comparison with FIG. 1, a three-quarter axonometric view from above of details of the automated finishing station of FIG. 1 constituting a sub-station of the same; and

FIG. 11 shows schematically orthogonal plant views from above and corresponding side views of finished vehicle brake elements, as well as details of respective sectional view thereof worked by means of the automated finishing station of FIG. 1.

### DETAILED DESCRIPTION

With reference to FIGS. from 1 to 11, the reference number 1 indicates as a whole an automated finishing station for vehicle braking elements 2 like a brake shoe or a brake pad, a couple of which are shown schematically, in a perspective view, in FIG. 8.

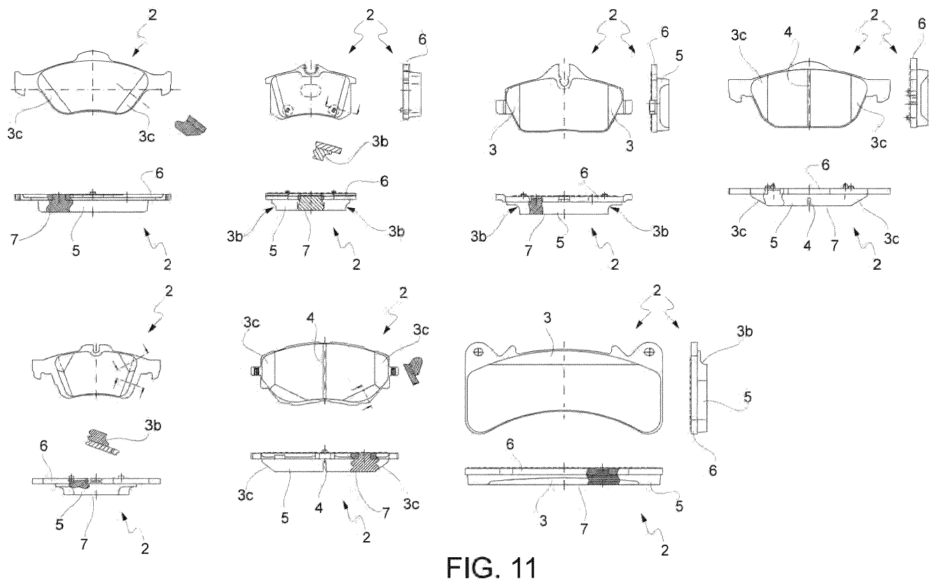

The finishing station Is configured for carrying out chamfers 3 and/or slots 4 (FIG. 11) on a block 5 of friction material carried by a (normally metallic) support 6, the block 5 of friction material and the support 6 forming together one vehicle braking element 2.

A number of braking elements 2, constituted by brake pads, are shown in FIG. 11, having different finishing, namely having their side edges provided with chamfers 3 of different shape and/or arranged in a different position, and/or having a central and transverse slot 4 provided on a first face 7 of the friction material block 5, opposite to the support 6 and facing in use towards the element to be braked (e.g. a brake disc).

In particular, chamfers 3b are known as J-chamfers and chamfer 3c flat chamfers and may have different inclinations with respect to the support 6, which is normally a flat plate. The brake elements 2 may be in themselves of different dimension and shape, depending on the vehicle they are designed to work with.

Braking elements 2 shown in FIG. 8 are still to be finished and any chamfer or slot is therefore missing.

The automated finishing station 1 comprises at least one robotized articulated arm 8 (also indicated herein below simply as “robot 8”) and at least one first grinding machining module 9 (also indicated herein below simply as “grinding module 9”) configured to remove/ablate part of the friction material block 5 on the side of the first face 7 thereof to obtain on such friction material block 5 one or more chambers 3 (e.g. 3b or 3c) and/or slots 4 of pre-established shape.

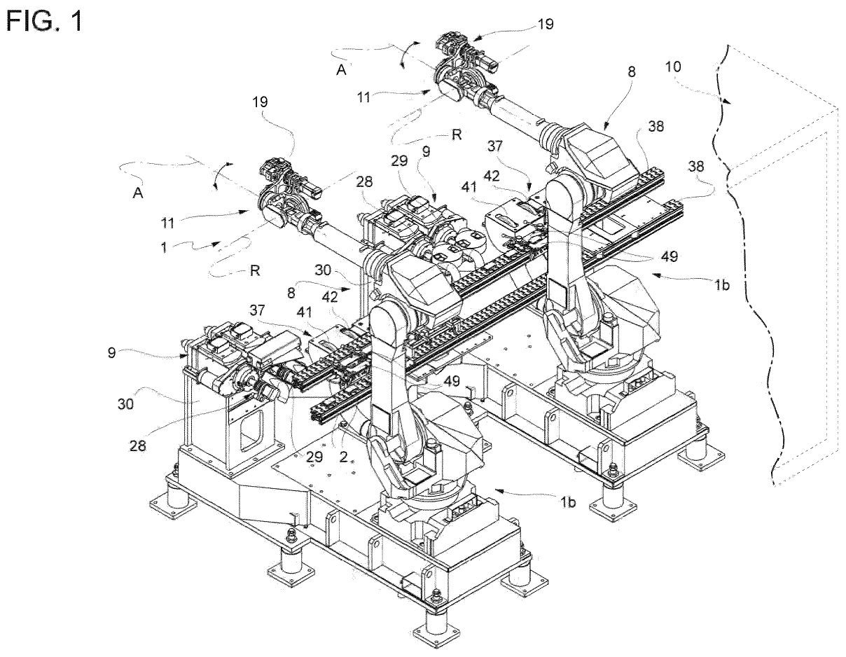

According to one preferred embodiment of the invention, the finishing station 1 is formed by the coupling of two identical sub-stations 1b as schematically shown in FIG. 1, arranged side by side and preferably surrounded by a protection cabin 10 (known and shown in part only for sake of simplicity).

Each sub-station 1b constitutes a complete finishing 30. station according to the invention according to the simplest embodiment thereof. Accordingly, the following description will refer either to one single finishing sub-station 1b or to the whole finishing station 1 without losing in generality.

The at least one robotized articulated arm 8 may be of known type and comprises a motorized head 11 rotating around first axis A (this first axis A is the sixth numerically controlled axis of robot 8, counting its six numerically controlled axes in ascending sequence from the base to the wrist, as usual in a commercial robot, as the robotized articulated arm 8 is).

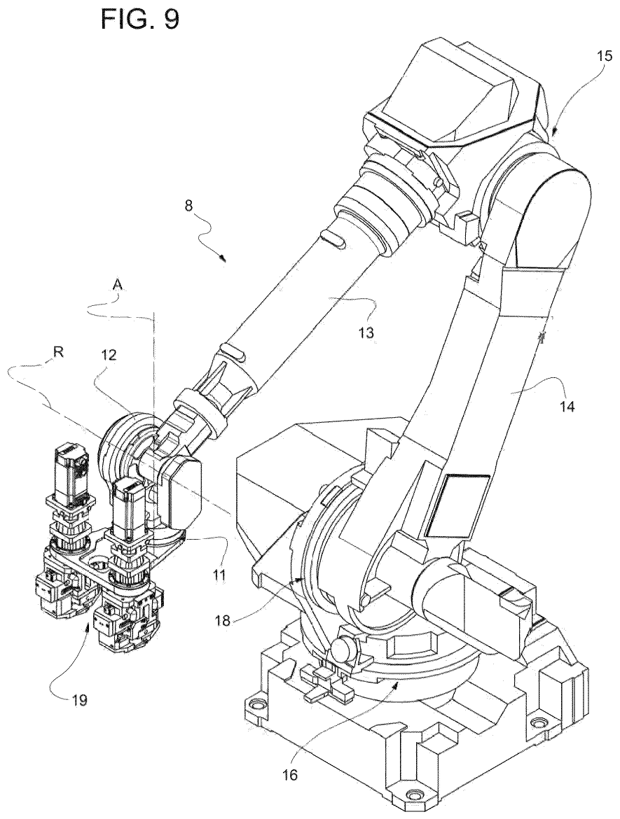

Preferably, the at least one robotized articulated arm 8 has six numerically controlled axes, including the first axis A; in particular, the motorized rotating head 11 may be supported by a motorized rotating joint 12 (FIG. 9)—which is the fifth numerically controlled axis of robot 8, according to the usual sequence used for commercial robots like robot 8 is—able to rotate the head 11 around an axis R perpendicular to the first axis A, as shown in FIGS. 1 and 9, wherein head 11 is arranged in two different positions in which its axis A is oriented, respectively, horizontal (FIG. 1) and vertical (FIG. 9).

Generally speaking, the robotized articulated arm 8 comprises (FIG. 9) two straight elements 13 and 14 connected to each other by a motorized joint 15, a motorized rotating base 16 and a further motorized rotating joint 18 connecting the base 16 with the straight element 14 more distant from the head 11.

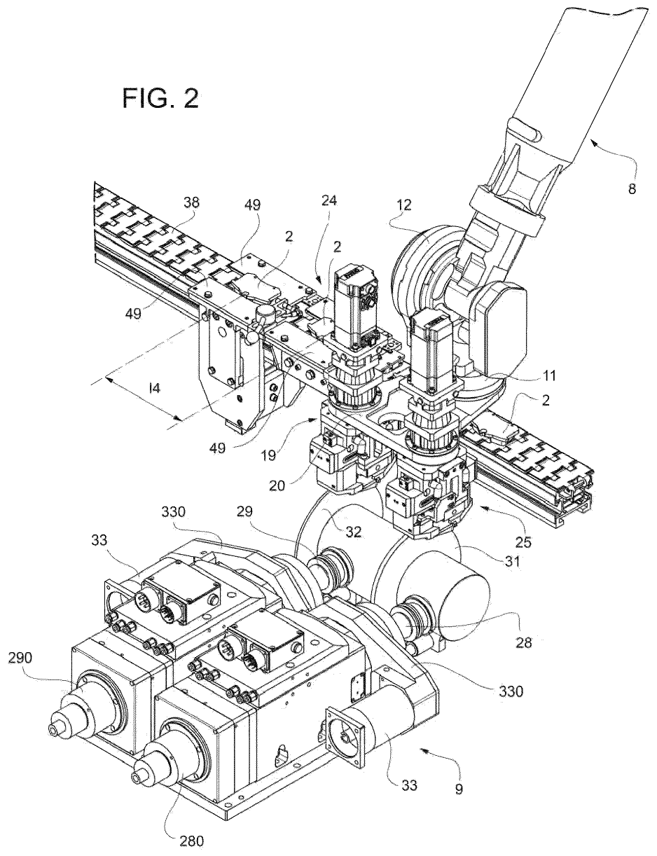

According to a first aspect of the present invention, the head 11 carries a tool 19, better shown in enlarged scale in FIGS. 2, 4 and 8.

The tool 19 comprises a rigid plate 20 having in plant view an “Y” shape, since plate 20 has two opposite ends 21, 22 (FIG. 8) of different width connected by tapering edges of preferably a curved configuration, so forming in plant view a sort of “deformed” triangle resembling just the shape of the capital Y.

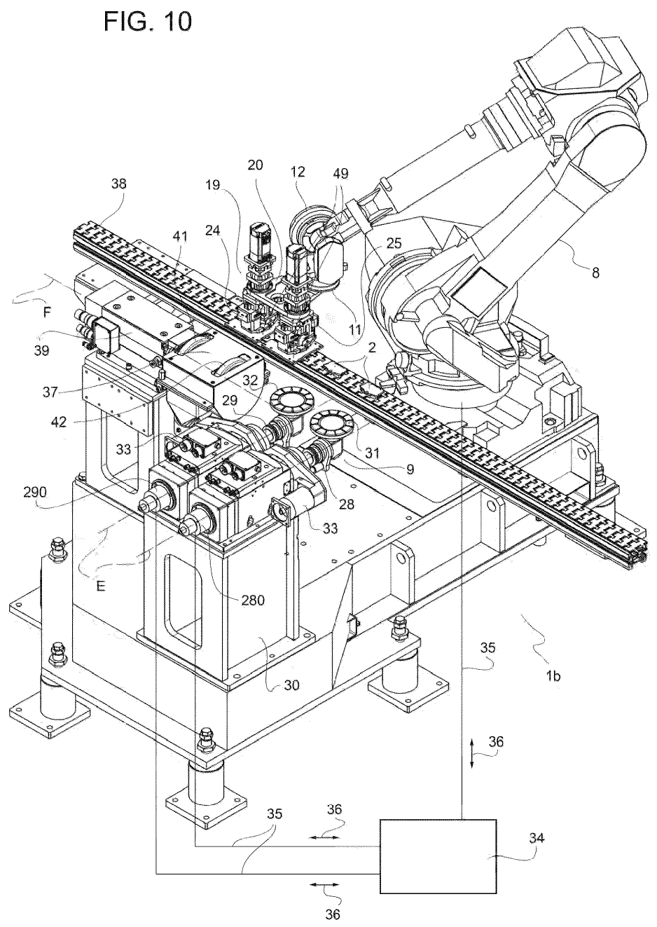

Plate 20 is attached integral to head 11 by means of its narrower end 22, e.g. by bolts (not shown) and is arranged substantially perpendicular to the first axis A. At this purpose, end 22 is provided with a crown of suitable seats 23 arranged in a circle around axis A and therefore plate 20 is compelled to rotate around axis A together with head 11. Accordingly, end 21 may be also rotated around axis A, eccentrically therefrom. See e.g. FIGS. 1 and 10 wherein plate 20 and end 21 appear to be rotated by 90°.

According to one aspect of the invention, the rigid plate 20 carries at end 20 a first motorized holding device. 24 and a second motorized holding device 25, identical to each other and arranged side by side at opposite side edged of end 21.

Each first and second motorized holding device 24, 25 comprises (FIG. 8) a motor 26 carried integral by the rigid plate 20 and a clamping assembly 27 configured to hold one vehicle braking element 2, so as the tool 19 is configured to carry on simultaneously two vehicle braking elements 2 at a time.

Moreover, the clamping assembly 27 of each first and second holding device 24, 25 is configured to be rotated by the corresponding motor 26, to the exit shaft (not shown) of which it is angularly connected, around a respective second axis B (FIG. 4).

The two second axes B of the first and of the second holding device 24, 25 (FIG. 4) are parallel to each other and to the first axis A and are arranged side by side, spaced apart with a first interaxis I1, i.e. at a distance I1 from each other and there between.

The second axes B are moreover arranged eccentrically to the first axis A and the first and second holding device 24,25 are configured to be operable independently of each other by the two independent motors 26.

The clamping assembly 27 of each first and second holding device 24, 25 is configured to hold one of the vehicle braking element 2 to be finished at a time by/at the support 6 thereof and on the side opposite to the first face 7 of the friction material block 5 thereof, keeping the first face 7 always parallel to the rigid plate 20 and facing towards the first grinding module 9.

According to a further aspect of the invention and in combination with the tool 19 described above, the first grinding module 9 comprises a first motorized head 28 and a second motorized head 29, both carried by a first stationary base 30 (FIGS. 1 and 10) arranged in proximity to the robotized articulated arm 8, i.e. well within its range of action, so as to be easily and quickly reachable by the head 11.

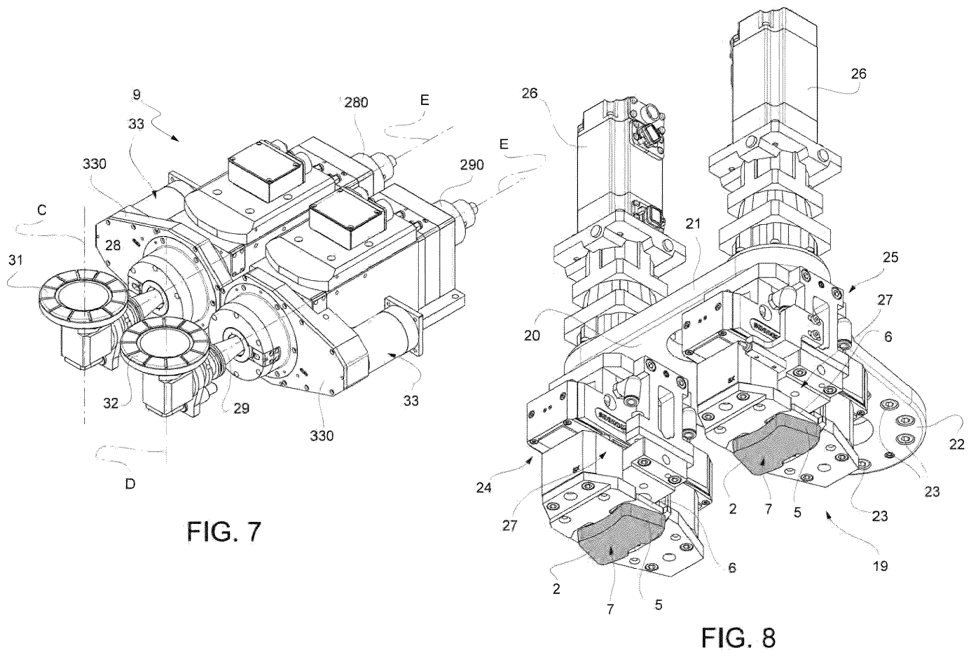

The first motorized head 28 supports one respective 25. first motorized grinding wheel 31 rotating around a third axis C (FIG. 7) which is also the axis of symmetry thereof, and the second motorized head 29 supports one respective second grinding wheel 32 rotating around a fourth axis Dr which is as well the axis of symmetry thereof.

Heads 28 and 29 are known as “angle heads”, since they are not directly motorized, but receive the motion from respective motorized spindles 280, 290 (FIGS. 2 and 7) by means of a pair of gears (known and not shown for sake of simplicity) that transfer motion to the grinding wheels 31, 32 let them to rotate around the axis C and D, respectively.

According to an aspect of the invention, the first and second “motorized” head 28, 29 are also rotatable, and configured to be rotated by respective motors 33 each around respective fifth axis E (FIG. 7).

In the non-limiting embodiment shown, the motors 33 are arranged each laterally the corresponding axis E and transmit the motion to the angle heads 28,29, rotating them independently of each other, each around one axis E, via a transmission gear 330 (known and not shown in details for sake of simplicity), so being able to also tilt of any angle the corresponding axis C, D.

The two axes E of the two motorized heads 28, 29 are in fact arranged side by side and parallel to each other and are perpendicular to the third and fourth axis C, D of rotation of the respective first and second grinding wheel 31, 32.

Moreover, according to a non-minor aspect of the invention, the fifth axes E are spaced apart with a second interaxis I2, i.e. by a distance measure perpendicularly to each other, identical to the first interaxis I1, i.e. the distance comprised between the couple of second axes B of the first and second holding device 24, 25, measured perpendicularly thereof.

The first and second angle head 28, 29 are rotatable around the respective fifth axes E independently of each 30. other owing to the couple of different and independent motors 33, so that the first grinding module 9 is configured to rotate the first and second motorized angle head 28, 29 by pre-established angles up to 90% or even 180°, identical or different to each other, in response to signals of a control unit 34 (FIG. 10).

The control unit 34 is an integral part of the automated finishing station 1 according to the invention and may serve both the sub-stations 1b or, in an embodiment not shown, the automated finishing station 1 may comprise two control units 34, one of each sub-station 1b.

The control unit 34 is connected to the at least one robotized articulated arm 8 and the at least one first grinding module 9 (with those of both the sub-stations 1b in the embodiment shown) via data cables 35, and controls the same via control signals 36 which run along the data cables 35.

The control unit 34 is configured to operate the robotized articulated arm 8 and to simultaneously rotate the first and second motorized holding devices 24, 25 and the first and second motorized heads 28, 29 of the first grinding module 9 provided with the respective first and second rotating grinding wheels 31, 32 in order to obtain on the block 5 of friction material a plurality of chamfers 3, in particular the flat chamfers 3c, of predetermined shape and in predetermined positions along respective sides of the block 5 of friction material.

In this manner, according to an important aspect of the invention, it is possible to perform chamfers in any position, and for obtaining the flat chamfer(s) it is possible to decide to obtain any angle with respect to the axis of the brake pad and any angle with respect to the backplate surface.

It is also evident, especially looking at the configuration shown in FIG. 2, that it would eventually be possible to obtain also slots 4 on face 7 by rotating in a suitable position the rotatable holding devices 24,25 and rotating of the same angle (e.g. 90%) and in the same direction the rotatable heads 28,29 and by providing the latter with grinding wheels 31, 32 of suitable shape, e.g. of thinner thickness with respect to the grinding wheels shown in FIGS. 7 and 10.

According to a further aspect of the invention, the automated finishing station 1 (in the embodiment shown both its sub-stations 1b) comprises, in combination with the first grinding module 9, a second grinding module 37 arranged side by side the first grinding module 9; both grinding modules 9, 37 are moreover arranged in front of the robotized articulated arm 8, as shown in FIGS. 1 and 10.

The automated finishing station 1 further comprises at least one conveyor 38 arranged between the robotized articulated arm 8 and the first and second grinding modules 9, 37 (FIGS. 2 and 10).

In the embodiment shown in FIG. 1 the finishing station 1 comprises two identical conveyors 38 arranged side by side between the two robots 8 on one side and the two couples of grinding modules 9, 37 on the other side, constituting the two sub-stations 1b.

In any case, the (each) conveyor 38 is configured to transport a plurality of vehicle braking elements 2 in a row along an empty space delimited between the robotized articulated arm 8 and the first and second grinding modules 9, 37 of either a complete finishing station 1 or both sub-stations 1b.

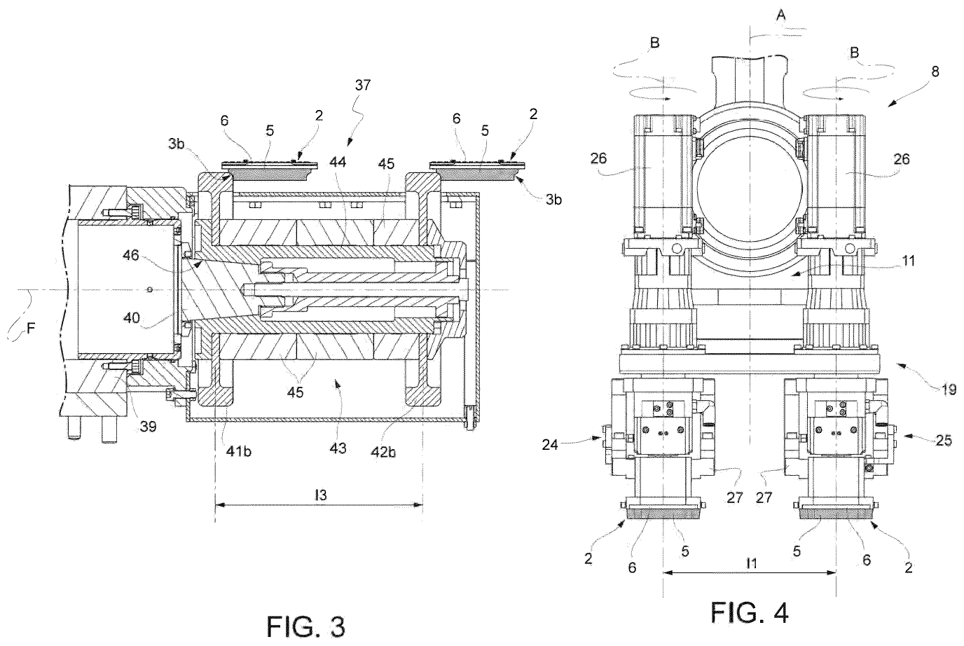

The (each) second grinding module 37 (FIGS. 3, 5 and 6) comprises a second stationary base 39 carrying a motorized shaft 40 rotating around a sixth axis F which also corresponds to its own axis of symmetry and which is arranged perpendicular to the fifth axes B.

The shaft 40 carries in a removable manner and side by side one third and one fourth grinding wheel, 41 and 42 respectively, assembled angularly rigid thereto and spaced apart from each other (FIG. 3) with a third interaxis I3, i.e. at a distance there between measured at the middle portions thereof.

According to one aspect of the invention, the third interaxis I3 is identical to the first and second interaxes I1 and I2.

The third and fourth grinding wheels 41, 42 are compelled to rotate around the sixth axis F together, at the same speed, being both angularly coupled with the shaft 40. Shaft 40 is moreover equipped with a quick assembly bearing unit 43 to connect the third and fourth grinding wheels 41, 42 to the shaft 40.

With reference to FIG. 3, the quick assembly bearing unit 43 comprises a tubular spindle 44 arranged coaxial with shaft 40 and configured to carry thereon the third and fourth grinding wheels 41, 42 angularly rigid thereto.

A number of spacers 45 are also carried by the spindle 44 to block the third and fourth grinding wheels 41, 42 together at the third interaxis I3.

Finally, the quick assembly bearing unit 43 comprises a quick connection device 46 to angularly connect head to head the spindle 44 to the shaft 40; this quick connection. device 46 is preferably of the Morse taper type, as shown in FIG. 3.

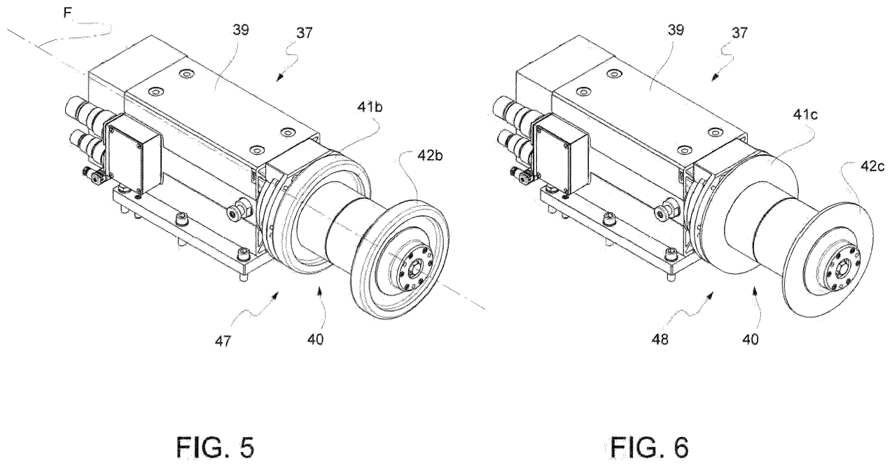

According to a further aspect of the invention, the automated finishing station 1 for each of both the sub stations 1b) comprises two sets 47, 48 of third and fourth grinding wheels 41, 42 (FIGS. 5, 6) interchangeably connectable to the motorized shaft 40.

The first set 47 includes a couple of grinding wheels 41b, 42b configured to obtain J-chamfers (as shown in FIG. 3) onto the blocks 5 of friction material of a pair of braking elements 2 to be finished held by the paired holding devices 24,25 as shown in FIG. 4.

The second set 48 includes a couple of grinding wheels 41c, 42c configured to obtain a slot 4 (so thinner than grinding wheels 41b, 42b) on the first face 7 of the friction material block 5 of a pair of braking elements 2 to be finished held by the paired holding devices 24,25 as shown in FIG. 4.

Depending on the shape of the grinding wheels 41b, 42b the obtained J chamfers may have different radius. Likewise slots can have different thickness and shape e.g. “U” shape and “V” shape, depending on the shape of the grinding wheels 41c, 42c.

As already mentioned, the automated finishing station 1 in its preferred embodiment comprises two robotized articulated arms 8 arranged side by side, each one served by a respective conveyor 38 and by a corresponding first and a second grinding modules 9, 37 arranges side by side in front of the corresponding robotized articulated arm 8 and on the side opposite thereto with reference to the corresponding conveyor 38, to form two paired sub-stations 1b working simultaneously.

Preferably, the (each) conveyor 38 is an endless belt conveyor of any known type, as schematically shown in FIGS. 1, 2 and 10.

According to a further aspect of the invention, the (each) conveyor 38 is provided with two pairs of positioning templates 49 for the vehicle braking elements 2 arranged in sequence, in tandem, along the conveyor 38 and operating on both sides thereof.

Each pair of positioning templates 49 is spaced apart by the other by a fourth interaxis I4 (FIG. 2) identical to the first interaxis I1, the fourth interaxis I4 being set between the middle portions of a pair of brake pads 2 blocked by the pair of templates 49 arranged side by side along the conveyor 38.

From what described until now, it is clear that the present invention also relates to a method for obtaining chamfers 3 and/or slots 4 on a block 5 of friction material carried by a support 6, the block 5 of friction material and the support 6 forming a vehicle braking element 2, the method being carried out by the finishing station 1 described above, by operating the at least one (both) robotized articulated arm 8 provided (each) with the tool 19 such as to manipulate two vehicle braking element 2 at a time to bring them simultaneously in contact with a respective pair of first and second grinding wheel 31, 32 or of third and fourth grinding wheel 41, 42 (see FIGS. 2 and 3) arranged side by side with an interaxis there between identical to a first interaxis at which the tool 19 holds the two vehicle braking element 2 at a time.

With the embodiment shown in FIG. 1, having two robotized articulated arms 8 and corresponding pairs of grinding modules 9, 37 it is clear that it is possible to obtain in sequence on the same braking elements 2 both chamfers 3 and slots 4.

In particular, J-chamfers may be obtained by means of module 37 equipped with grinding wheels 41b, 42b, while flat chamfers and/or slots may be obtained rotating in a suitable manner both the tool 19 by the head 11 and the two holding devices 24, 25 supported thereby, and by rotating simultaneously the two motorized heads 28, 29, provided that the module 9 is provided with grinding wheels of suitable shape and thickness.

In case the module 37 is used to provide both J-chamfers and slots, this will be made possible by replacing the grinding wheels 41b, 42b with grinding wheels 41c, 42c, operation made quick, easy and possible by the quick release and assembly bearing unit 43.

All the aims of the present disclosure are therefore fulfilled.

### Certain Terminology

Although certain braking devices, systems, and methods have been disclosed in the context of certain example embodiments, it will be understood by those skilled in the art that the scope of this disclosure extends beyond the specifically disclosed embodiments to other alternative embodiments and/or uses of the embodiments and certain modifications and equivalents thereof, like brake shows for braking systems based on brake drums. Use with any structure is expressly within the scope of this invention. Various features and aspects of the disclosed embodiments can be combined with or substituted for one another in order to Form varying modes of the assembly The scope of this disclosure should not be limited by the particular disclosed embodiments described herein.

Conditional language, such as “can,” “could,” “might,” or “may,” unless specifically stated otherwise, or otherwise understood within the context as used, is generally intended to convey that certain embodiments include or do not include, certain features elements, and/or steps. Thus, such conditional language is not generally intended to imply that features, elements, and/or steps are in any way required for one or more embodiments.

Unless stated otherwise, the terms “approximately,” “about,” and “substantially” as used herein represent an amount close to the stated amount that still performs a desired function or achieves a desired result. For example, in some embodiments, as the context may dictate, the terms “approximately” “about”, and “substantially” may refer to. an amount that is within less than or equal to 10% of the stated amount. Likewise, the term “generally” as used herein represents value, amount, or characteristic that predominantly includes or tends toward a particular value, amount, or characteristic.

This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

1. An automated finishing station (1) for vehicle braking elements (2) like a brake shoe or a brake pad, configured for carrying out chamfers and/or slots on a block (5) of friction material carried by a support (6), the block of friction material and the support forming a vehicle braking element (2), the automated finishing station (1) comprising:
at least one robotized articulated arm (8); and
at least a first grinding module (9) configured to remove/ablate part of the friction material block (5) on the side of a first face (7) thereof to obtain on such friction material block one or more chamfers (3) and/or slots (4) of pre-established shape; wherein, in combination:
i)—the robotized articulated arm (8) comprises a head (11) rotating around a first axis (A);
ii)—the said head (11) carries a tool (19) comprising a rigid plate (20) attached integral to said head (11) and arranged substantially perpendicular to said first axis (A), the rigid plate (20) carrying a first and a second motorized holding device (24,25), the motorized holding devices being arranged side by side;
iii)—each said first and second motorized holding device (24,25) comprises a motor (26) carried integral by said rigid plate (20) and a clamping assembly (27) configured to hold one said vehicle braking element (2), so as said tool (19) is configured to carry on simultaneously two said vehicle braking elements (2),
iv)—the clamping assembly (27) of each said first and second holding device (24,25) is configured to be rotated by the corresponding said motor (26) around a respective second axis (B), the second axes (B) of the first and of the second holding device is parallel to each other and to the first axis (A) and is arranged side by side, spaced apart with a first interaxis (I1), i.e. a distance there between, the second axes (B) is arranged eccentrically to the first axis (A), the first and second holding device (24,25) are operable independently of each other by said motors (26); and
v)—the clamping assembly (27) of each said first and second holding device (24,25) is configured to hold one said vehicle braking element (2) at a time by the support (6) thereof and on the side opposite to said first face (7) of the friction material block (5) thereof, keeping said first face (7) parallel to said rigid plate (20) and facing towards said first grinding module (9).

2. The automated finishing station according to claim 1, wherein:
vi)—said first grinding module (9) comprises a first and a second motorized head (28,29) carried by a first stationary base (30) arranged in proximity to the robotized articulated arm (8), the first motorized head (28) supports one respective first grinding wheel (31) rotating around a third axis (C) which is its own axis of symmetry, and the second motorized head (29) supports one respective second grinding wheel (32) rotating around a fourth axis (D) which is its own axis of symmetry;
vii) the first and second motorized head (28,29) are rotatable around respective fifth axes (E) arranged side by side and parallel to each other and perpendicular to the third (C) and fourth (D) axis of rotation of the respective first and second grinding wheel; and
viii) the fifth axes (E) is spaced apart with a second interaxis (I2), i.e. a distance from each other, identical to said first interaxis (I1), i.e. the distance comprised between the second axes (B) of the first and second holding device (24,25).

3. The automated finishing station according to claim 2, wherein said first and second motorized head (28,29) are rotatable around the respective fifth axes (E) independently of each other, the first grinding module (9) being configured to rotate the first and second motorized head (28,29) by pre-established angles up to 90° or 180°; identical or different to each other, in response to signals (36) of a control unit (34).

4. The automated finishing station according to claim 1 wherein
the automated finishing station comprises a control unit (34) for said at least one robotized articulated arm (8) and for said the at least one first grinding module (9); and
the control unit (34) is configured to operate the robotized articulated arm (8) and to simultaneously rotate the said first and second motorized holding devices (24,25) and first and second motorized heads (28,29) of said first grinding module (9) provided with respective first and second rotating grinding wheels (31,32) in order to obtain on said block (5) of friction material a plurality of chamfers (3) of predetermined shape and in predetermined positions along respective sides of the block (5) of friction material.

5. The automated finishing station according to claim 1 wherein the automated finishing station further comprises;
a second grinding module (37) arranged side by side the first grinding module (9) and in front of said robotized articulated arm (8); and
at least one conveyor (38) arranged between said robotized articulated arm (8) and said first and second grinding modules (9,37) and configured to transport a plurality of vehicle braking elements (2) in a row along an empty space delimited between said robotized articulated arm (8) and said first and second grinding modules (9,37).

6. The automated finishing station according to claim 5, wherein
the second grinding module (37) comprises a second stationary base (39) carrying a motorized shaft (40) rotating around a sixth axis (F), corresponding to its own axis of symmetry and arranged perpendicular to said fifth axes (E);
said shaft (40) carries in a removable manner and side by side one third and one fourth grinding wheel (41,42) angularly rigid thereto and spaced apart with a third interaxis (i3), i.e. at a distance there between, identical to the first and second interaxes (I1,I2);
the third and fourth grinding wheels (41,42) are compelled to rotate around the sixth axis (F) together, at the same speed; and
the said shaft (40) is equipped with a quick assembly bearing unit (43) to connect said third and fourth grinding wheels (41,42) to said shaft (40).

7. The automated finishing station according to claim 6, wherein said quick assembly bearing unit (43) comprises:
a tubular spindle (44) arranged coaxial with said shaft (40) and configured to carry said third and fourth grinding wheels (41,42) angularly rigid thereto;
a number of spacers (45) carried by the spindle (44) to block the third and fourth grinding wheels (41,42) together at the third interaxis (I3); and
a quick connection device (46) to angularly connect head to head the spindle (44) to the shaft (40), said quick connection device (46) being preferably of the Morse taper type.

8. The automated finishing station according to claim 6, wherein the automated finishing station further comprises:
two sets (47,48) of said third (41b,41c) and fourth (42b,42c) grinding wheels interchangeably connectable to said motorized shaft (40); and
a first set (47) configured to obtain J-chamfers onto said blocks (5) of friction material and a second set configured to obtain a slot (4) on said first face (7) of the friction material block.

9. The automated finishing station according to claim 1, preceding wherein
said at least one robotized articulated arm (8) has six numerically controlled axes, including said first axis (A); and
the automated finishing station (1) comprises two said robotized articulated arms (8) arranged side by side, each one served by a respective conveyor (38) and by a first and a second grinding modules (9,37) arranged side by side in front of the corresponding robotized articulated arm (8) and on the side opposite thereto with reference to the corresponding conveyor (38).

10. The automated finishing station according to claim 9, wherein each said conveyor (38) is an endless belt conveyor and is provided with two pairs of positioning templates (49) for said vehicle braking elements (2) arranged in sequence, in tandem, along the conveyor (38) and operating on both sides thereof, the pairs of positioning templates (49) being spaced apart by a fourth interaxis (I4) identical to said first interaxis (I1).

11. A method comprising:
obtaining chamfers (3) and/or slots (4) on a block (5) of friction material carried by a support (6), the block of friction material and the support forming a vehicle braking element (2);
operating at least one robotized articulated arm (8) provided with a tool (19) such as to manipulate two said vehicle braking element (2) at a time; and
bringing the vehicle braking elements (2) simultaneously in contact with a respective pair of first and second grinding wheel (31,32) or of third and fourth grinding wheel (41,42) arranged side by side with an interaxis there between identical to a first interaxis (I1) to which the tool (19) holds said two vehicle braking elements (2) at a time.
